(19) United States
(12) Patent Application Publication
(10) Pub. No.: US 2013/0006659 A1
(43) Pub. Date: Jan. 3, 2013

(54) SYSTEM AND METHOD FOR REMOTE PHYSICAL THERAPY

(76) Inventor: Michael Donnelle Mills, Litchfield Park, AZ (US)

(21) Appl. No.: 13/540,560

(22) Filed: Jul. 2, 2012

Related U.S. Application Data
(60) Provisional application No. 61/504,215, filed on Jul. 3, 2011.

(51) Int. Cl. G06Q 50/22

(52) U.S. Cl. 705/2

(57) ABSTRACT

The present invention generally relates to remote physical therapy applications. In particular, the system and methods herein described relate to the provision of remote physical therapy services over one or more networks whereby a patient can receive physical therapy services from one or more physical therapy service providers without requiring the patient to visit a particular physical location.

### CROSS REFERENCE TO RELATED APPLICATIONS

This application claims the benefit of U.S. Provisional Patent Application No. 61/504,215 filed Jul. 3, 2012, the entire disclosure of which is incorporated herein by reference.

### FIELD OF THE INVENTION

The present invention generally relates to remote physical therapy applications. In particular, the system and methods herein described relate to the provision of remote physical therapy services over one or more networks whereby a patient can receive physical therapy services from one or more physical therapy service providers without requiring the patient to visit a particular physical location.

### BACKGROUND

The provision of physical therapy for the treatment of certain injuries has become ubiquitous in current times. Even as more and more individuals become engaged in the receipt of physical therapy for injuries, there remain several hurdles and complications to receiving appropriate physical therapy for numerous patients.

Firstly, it can be complicated to select an appropriate physical therapist as there are numerous types of injuries and treatment styles. Not every injury type is treated by each physical therapist and treatment styles may vary from therapist to therapist. It is currently difficult to match patients with appropriate physical therapist.

Secondly, due to physical limitations or other constraints of a patient, going to a physical therapist may be difficult or at least inconvenient. Travel and timing can be complicated when dealing with busy schedules and injuries that may limit a patient's ability to move.

Lastly, current requirements for physical therapy require that a patient actually visit the physical therapist in person. With advances in modern computing technologies and communications means, it is posited that many of the services provided by a physical therapist could be provided remotely, where these services are not provided as such in today's environment.

Therefore, there is a need in the art for a system and method for providing remote physical therapy. These and other features and advantages of the present invention will be explained and will become obvious to one skilled in the art through the summary of the invention that follows.

### SUMMARY OF THE INVENTION

Accordingly, it is an object of the present invention to provide a system and method configured to provide remote physical therapy.

According to an embodiment of the present invention, a web-based system for providing remote physical therapy includes: a server comprising computer-executable code stored in non-volatile memory and a communications means, wherein the computer-executable code and the communications means are operably connected; and wherein the computer-executable code and communications means are configured to collectively perform the steps of: receiving patient information from a patient; matching the patient with one or more physical therapist based at least in part on the patient information; receiving a selection of a selected physical therapist from the patient, wherein the selected physical therapist is selected from the one or more physical therapist; receiving patient injury information from the patient; providing the patient injury information to the selected physical therapist; generating a treatment plan based at least in part on the patient injury information; and transmitting the treatment plan to the patient.

According to an embodiment of the present invention, the treatment plan is first reviewed by the selected physical therapist prior to the transmitting step.

According to an embodiment of the present invention, the patient injury information may include video.

According to an embodiment of the present invention, the patient injury information may include audio.

According to an embodiment of the present invention, the treatment plan may include audio.

According to an embodiment of the present invention, the treatment plan may include video.

According to an embodiment of the present invention, the treatment plan may be tracked and updated by the patient.

According to an embodiment of the present invention, the treatment plan may be tracked and updated by the selected physical therapist.

According to an embodiment of the present invention, a web-based method for providing remote physical therapy, the method includes the steps of: receiving patient information from a patient; matching the patient with one or more physical therapist based at least in part on the patient information; receiving a selection of a selected physical therapist from the patient, wherein the selected physical therapist is selected from the one or more physical therapist; receiving patient injury information from the patient; providing the patient injury information to the selected physical therapist; generating a treatment plan based at least in part on the patient injury information; and transmitting the treatment plan to the patient.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention; and

FIG. 3 is a flowchart of an exemplary method in accordance with an embodiment of the present invention.

### DETAILED SPECIFICATION

The present invention generally relates to remote physical therapy applications. In particular, the system and methods herein described relate to the provision of remote physical therapy services over one or more networks whereby a patient can receive physical therapy services from one or more physical therapy service providers without requiring the patient to visit a particular physical location.

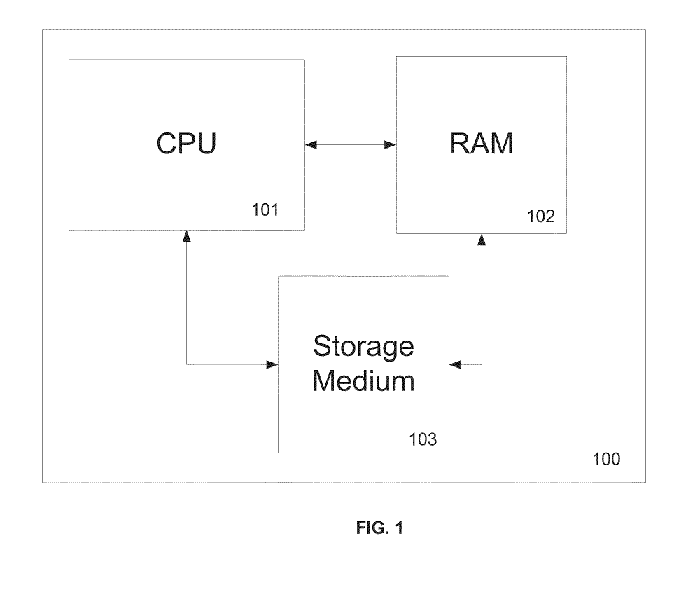

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

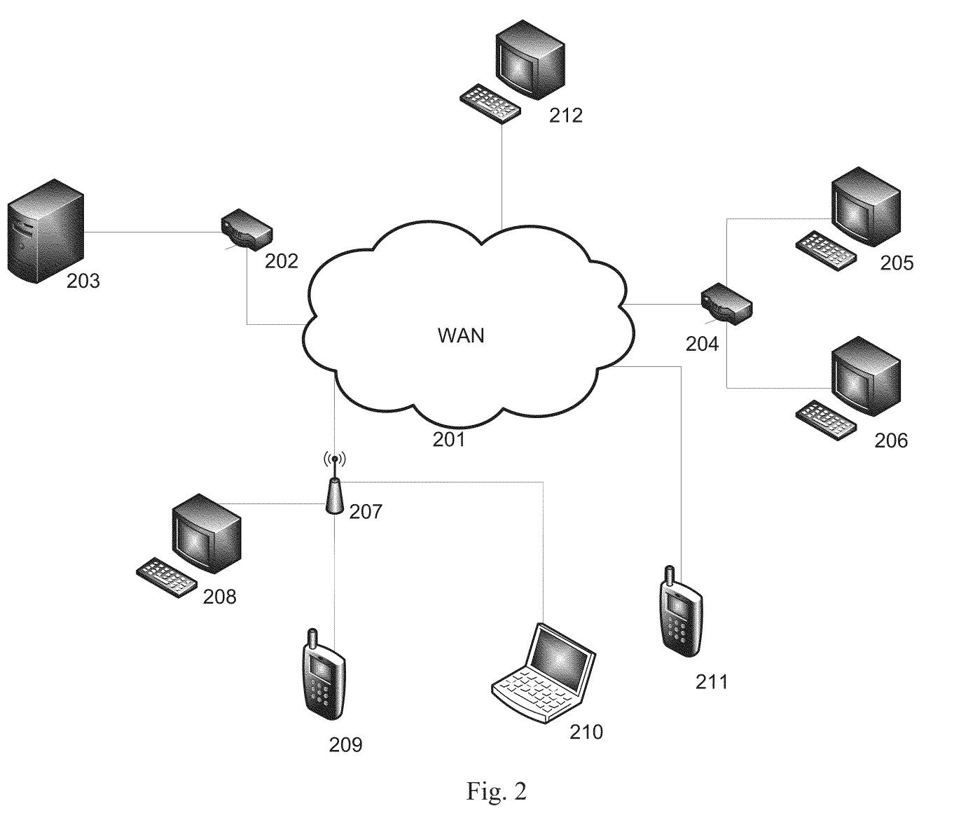

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, an individual or organization may signup to become a user of the system herein provided. In an exemplary embodiment, an individual or organization would go through a registration process, whereby they would provide identifying information to be stored in a server 203. This identifying information may be used, for instance, to identify the user, verify certifications or credentials or secure their login. One of ordinary skill in the art would appreciate there are numerous ways to provide and manage registration processes, and embodiments of the present invention are contemplated for use with any method for providing and managing registration processes.

According to an embodiment of the present invention, once a user is registered, he may be provided access to information regarding one or more licensed physical therapist, and their practices. Information includes, but is not limited to, biographical information, ratings, hours, services provided, specialties, reviews, types of insurance accepted and size of a practice. One of ordinary skill in the art would appreciate that there are numerous types of information regarding one or more licensed physical therapist that may be stored and presented to users in accordance with embodiments of the present invention, and embodiments of the present invention are contemplated for use with any type of information.

According to an embodiment of the present invention, the systems and methods herein described are configured to allow a user to make a selection as to which therapist they would like to work with. The decision of which therapist a user should choose or can choose is assisted in part by the stored and presented information. Other variables may be utilized as well, such as whether a particular therapist is accepting new patients, whether the user and a therapist have a previous relationship and/or whether the user's insurance company recommends or pre-selects one or more therapists.

In an alternate embodiment of the present invention, the system and methods herein described may match users and therapist based on these variables or based upon a matching algorithm. For instance, a matching algorithm may be utilized to align a user and a therapist based on a round-robin method assuring all participating therapist receive clients via the systems and methods herein described. Alternatively, a matching algorithm may be utilized to align a user and a therapist based on the type of injury and severity of injury, whereby the selected therapist would be certified or otherwise specialized in treating the specific type of injury. One of ordinary skill in the art would appreciate that there are numerous matching algorithms that could be utilized with embodiments of the present invention, and embodiments of the present invention are contemplated for use with any matching algorithm.

According to an embodiment of the present invention, once the user has been matched with a therapist, the system and methods herein described may be configured to collect information regarding the user's injuries. This may occur prior to being matched, after being matched or any combination thereof. For instance, certain information may have been collected by the system prior to matching and then the system, as configured to the therapist's specifications may require or request additional information.

According to an embodiment of the present invention, the system and methods herein described may be configured to allow the therapist the ability to review the information submitted by the user. The system may allow a therapist, or those associated with the therapist, to configure and personalize the receiving and review of the submitted information. This may be by way of, for instance, application programming interfaces (APIs) provided by the system that allow for extendibility of the system by third-party systems. Additionally, the system may be configured by the therapist to automate some or all of the receiving and review of submitted information process. For instance, the system may allow the therapist to receive information related to the injury of the user, such as limits on mobility of a particular joint. Video, images or other information received from the user may be automatically reviewed and analyzed by the system herein described and the system may be configured to form a treatment plan based on the severity of the injury and the limitations identified from the information. In an exemplary embodiment, where creation of treatment plans are automated, the therapist would still have a manual review of the resulting treatment plan to confirm its safety and applicability to the user. Alternatively, the therapist may manually review the information and develop a treatment plan for the user. The treatment plan will typically consist of one or more exercises for the user to complete on a set or mutable schedule.

According to an embodiment of the present invention, the system herein described may be configured to assist the user with following the treatment plan provided by the system or the therapist. The system may be configured to provide the user a regimented weekly schedule for their workouts. The system may be further configured to provide an online, networked, offline or any combination thereof method for providing instructional videos or other multimedia content related to each exercise of the treatment plan. The system may also be further configured to provide an online, networked, offline or any combination thereof method for providing instructional animations, demonstrating particular motions, movements or other methods for properly executing one or more exercises. Instructional animations may be provided in various levels of difficulty, indicating the progress along the path to full recovery by a user.

According to an embodiment of the present invention, the system herein described may be configured to play the videos, instructional animations or other multimedia content in an specific order as identified in the treatment plan. Advantageously, the organization of the videos, instructional animations or other multimedia content makes it easier on the individual to follow and provides the benefit of allowing the therapist to assemble the treatment plan in a safe and convenient manner. For instance, videos and instructional animations may be organized in such a manner that easier/warm-up exercises are placed before harder, more strenuous exercises.

According to an embodiment of the present invention, the system herein described may be configured to record or log certain aspects of the workout performed by the user. For instance, a webcam or microphone may be utilized to record the workout for later review by the therapist. Other devices may be connected to the user's computing device or other electronic equipment utilized to record other aspects of the workout. For instance, a heart-rate monitor may be connected to the system and allow for the recording of a user's heart-rate during a workout. Other devices that may be utilized with the system include, but are not limited to, blood-pressure monitors, 3D recording modules, repetition counters and range of motion monitors. One of ordinary skill in the art would appreciate that there are numerous devices that could be used to enhance the data recorded by the system during a user's workout, and embodiments of the present invention are contemplated for use with any such device.

According to an embodiment of the present invention, the system herein described may be configured to chart and track goals contained in the treatment plan. These charts may be updated at any given interval, such as weekly, daily or even on-the-fly as requested by either the user or the therapist. These charts and goals may also be used by the system to recalculate treatment plans on the fly in response to progress (or lack thereof) a user has made. The system may be further configured to send warning indicators (e.g., e-mails, alerts, sms) may be sent to the therapist where a user is falling behind on the goals set in the treatment plan.

According to an embodiment of the present invention, the system herein described may be configured to notify the user of an upcoming workout. Notifications may be provided in one or more format, preferably an electronic format (e.g., e-mail, sms, social network, calendar event). One of ordinary skill in the art would appreciate that there are numerous ways to provide notifications, and embodiments of the present invention are contemplated for use with any method for providing notifications.

According to an embodiment of the present invention, the system herein described may be configured to allow users to able to monitor/share their rehabilitation progress. Progress may be shared with the user's therapist or other users of the system. Optionally, the system may also be configured to allow for progress to be shared outside the system as well (e.g., via social networks, via e-mail).

According to an embodiment of the present invention, the system herein described may be configured to allow a user to ask questions to their therapist via one or more communication tools. Communication tools include, but are not limited to, e-mail, VoIP communications, phone calls and SMS messages. One of ordinary skill in the art would appreciate that there are numerous ways to provide communications between a user and a therapist, and embodiments of the present invention are contemplated for use with any method of communication provision.

According to an embodiment of the present invention, the system herein described may be configured to allow a user to schedule online/in-person/phone appointments with a therapist. Additionally, therapist may request to schedule time with a user.

According to an embodiment of the present invention, the system herein described may be configured to provide treatment and feedback to the user. As previously noted, treatment may be manually, automatically or semi-automatically provided by the system. Additionally, feedback may also be provided manually, automatically or semi-automatically. For instance, the therapist may pre-configure feedback for a user based on particular results achieved by the user.

According to an embodiment of the present invention, the system herein described may be configured to provide feedback and treatment until the treatment plan has been completed or till the individual terminates their subscription. Alternatively, as a user progresses, the system may be configured to allow the user to switch to a different therapist for one or more reasons. For example, if a user was with a specialized therapist for a particular injury, as that injury heals, they may not need the services of the specialized therapist and may be transferred to a general therapist for completion of treatment. In yet another alternate embodiment, the user may transfer to a different therapist because they did not like the treatment or the therapist they were initially matched with or choose.

### EXEMPLARY EMBODIMENTS

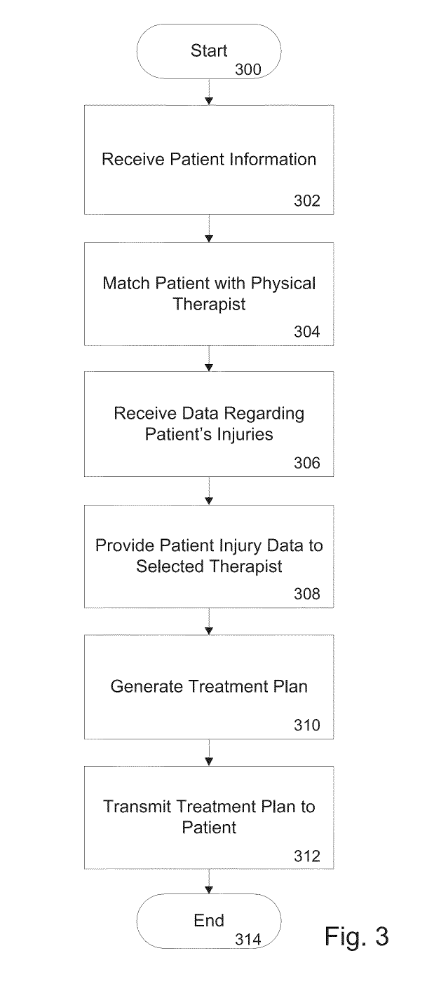

The following is an exemplary embodiment of a method for providing remote physical therapy, as shown in FIG. 3. At step 300, the process starts with the a patient connecting to the system in order to engage or start the process of receiving remote physical therapy.

At step 302, the patient provides, and the system receives, information regarding the patient. As noted above, this could occur during the registration process or in cases where the patient is already registered, this could comprise retrieving stored information, such as that stored in a database, data store or other storage medium.

At step 304, the system matches the patient with one or more physical therapist. The matching can be based at least in part on the patient information. The matching can be further based on information provided by the patient with regards to the type of physical therapist the patient is looking for (e.g., specialist, sub-specialist, large practice, small practice, geographic location). In a preferred embodiment, the patient is provided a list of matched physical therapist, from which the patient will select one or more physical therapist.

At step 306, the system receives information about the patient's particular injuries from the patient. The system may be configured to guide the patient through selecting the injuries, severity and other characteristics of the injury. Step 306 may occur, in the alternative, at the same time as step 302 in order to help the matching and selection of an appropriate physical therapist.

At step 308, the system is configured to provide information regarding the patient and the patient's injuries to the selected physical therapist for review and development of a treatment plan.

At step 310, in conjunction with information received from the matched physical therapist, the system generates a treatment plan based at least in part on the patient's injuries, input from the selected physical therapist. Once generated, the selected physical therapist may be given the opportunity to review the treatment plan prior to providing the treatment plan to the patient.

At step 312, the complete treatment plan is provided to the patient. The system may be further configured to monitor the progress of the patient, handle questions from the patient related to the treatment plan and any exercise or other treatment included in the plan.

At step 314, the process terminates.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A web-based system for providing remote physical therapy, the system comprising:
a server comprising computer-executable code stored in non-volatile memory and a communications means,
wherein said computer-executable code and said communications means are operably connected; and
wherein said computer-executable code and communications means are configured to collectively perform the steps of:
receiving patient information from a patient;
matching said patient with one or more physical therapist based at least in part on said patient information;
receiving a selection of a selected physical therapist from said patient, wherein said selected physical therapist is selected from said one or more physical therapist;
receiving patient injury information from said patient;
providing said patient injury information to said selected physical therapist;
generating a treatment plan based at least in part on said patient injury information; and
transmitting said treatment plan to said patient.

2. The web-based system of claim 1, wherein said treatment plan is first reviewed by said selected physical therapist prior to said transmitting step.

3. The web-based system of claim 1, wherein the patient injury information may include video.

4. The web-based system of claim 1, wherein the patient injury information may include audio.

5. The web-based system of claim 1, wherein the treatment plan may include audio.

6. The web-based system of claim 1, wherein the treatment plan may include video.

7. The web-based system of claim 1, wherein the treatment plan may be tracked and updated by the patient.

8. The web-based system of claim 1, wherein the treatment plan may be tracked and updated by the selected physical therapist.

9. A web-based method for providing remote physical therapy, the method comprising the steps of:
receiving patient information from a patient;
matching said patient with one or more physical therapist based at least in part on said patient information;
receiving a selection of a selected physical therapist from said patient, wherein said selected physical therapist is selected from said one or more physical therapist;
receiving patient injury information from said patient;
providing said patient injury information to said selected physical therapist;
generating a treatment plan based at least in part on said patient injury information; and
transmitting said treatment plan to said patient.

10. The web-based method of claim 9, wherein said treatment plan is first reviewed by said selected physical therapist prior to said transmitting step.

11. The web-based method of claim 9, wherein the patient injury information may include video.

12. The web-based method of claim 9, wherein the patient injury information may include audio.

13. The web-based method of claim 9, wherein the treatment plan may include audio.

14. The web-based method of claim 9, wherein the treatment plan may include video.

15. The web-based method of claim 9, wherein the treatment plan may be tracked and updated by the patient.

16. The web-based method of claim 9, wherein the treatment plan may be tracked and updated by the selected physical therapist.
